(19) United States
(12) Patent Application Publication
(10) Pub. No.: US 2006/0146535 A1
(43) Pub. Date: Jul. 6, 2006

(54) Fluorescent working light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/026,393

(22) Filed: Dec. 30, 2004

(51) Int. Cl. F21L 4/00

(52) U.S. Cl. 362/260; 362/190

(57) ABSTRACT

This present invention is relates to a fluorescent working light and more particularly, to a fluorescent working light with a handle and two supporting legs. Said two supporting legs may move relatively and interactively between position one and position two. If both said supporting legs are adjusted to an angle over 90°, user may place said light on shoulder to provide long distance lighting. Said supporting legs can also provide an adjustable mean with a tight or loose positions so as to controlling such supporting legs in a locked position or in a rotating position to reach said best lighting range and lighting angles through said attached hinge to any position within 270 degrees circular ark. Said present invention is an important source of light used in marine, army, public security, firefighting, emergency treatment, disciplined troop, architecture and civil vessels, as well as emergency treatment in daily life.

### BACKGROUND OF SAID PRESENT INVENTION

1. Field of Invention

Said present invention is relates to a fluorescent working light and more particularly, to a fluorescent working light with a handle and two supporting legs. Said two supporting legs may move relatively and interactively between position one and position two. If both said supporting legs are adjusted to an angle within 180°, user may place said light on shoulder to provide long distance lighting.

2. Description of Related Arts

Currently, most of said lighting equipment used at home or other places, which may be directly plugged to said external power source, allow said user to hold them by hand, or they may be affixed to said wall and ceiling.

Fluorescent working light with focused beams, spotlights or searchlights, whether battery-powered or line-powered, are commonly used by military, law enforcement, fire and rescue personnel, security personnel, hunters and recreational boaters among others for nighttime surveillance in any application where a high intensity spotlight is required. Said conditions of use are highly varied, but generally require said light to deliver a desired field of view at long distances, be reliable, durable and field maintainable in order for it to be practically used in said designed applications. Typically said light is hand carried and must be completely operable using simple and easily access manual controls, which do not require said use of two hands. In prior art xenon short-arc searchlights or illumination systems, whether handheld, portable or fixed mounted, said luminance distribution of said arc has been positioned facing in said direction of said beam (cathode to said rear), to provide a uniform beam pattern when said arc is at said focal point of said parabolic reflector. When said arc is moved slightly beyond (or slightly rearward of) said reflector's focal point, said combination of a placing all available light in said high magnification section of said reflector and collecting it in a slightly convergent manner produces roughly twice said operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, said lighting range, lighting angles and said lighting power of a candle are minimal. Such lantern light up by a candle will not be said most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. Said mounting is a tripod mount so that said portable searchlight may be fixed in said field to a tripod with said second device. Said mounting on said handle is a thumbscrew mount to permit mounting of an optical detection device onto said searchlight and rigidly fixed to said housing. However, this lantern provide without no ability to move any angle to obtain a better light range.

### SUMMARY OF SAID PRESENT INVENTION

Said main object of said present invention is to provide a fluorescent working light having a supporting means and such supporting means can provide an ability to rotate an angle within 180 degree so as to provide a platform for user to place said fluorescent working light on shoulder.

Another object of said present invention is to provide a fluorescent working light having a supporting means and such supporting mean can provide an ability to rotate and/or to move any angles within 180 degree circular arc.

Another object of said present invention is to provide a fluorescent working light having an ability to adopt difference power source supplies.

Another object of said present invention is to provide a fluorescent working light having a supporting means and such supporting mean can provide an adjustable mean with a tight or loose positions so as to controlling such supporting legs in a locked position or in a rotating position to reach said best lighting range and lighting angles.

Accordingly, to achieve said above objects, a fluorescent working light comprises:
a three dimensional cylinder housing, inside of it contains a mean of lighting source;
a plurality of reflector is fixed around said mean of light source; and
a transparent front flat board;
a sealed packing collar is connecting a inner portion of said transparent front flat board and said reflector which resides inside of an annular nut. Said annular nut providing a fixed position and a disassembled position on front portion of said housing. Surface of said annular nut, which is located in front of said housing, set an annular shockproof nut. It is made of rubber or other soft material to prevent said fluorescent working light flood light from shocks or quakes when excessive external force applied to it.

### BRIEF DESCRIPTION OF SAID DRAWINGS

FIG. 1 is a front view of said present invention.

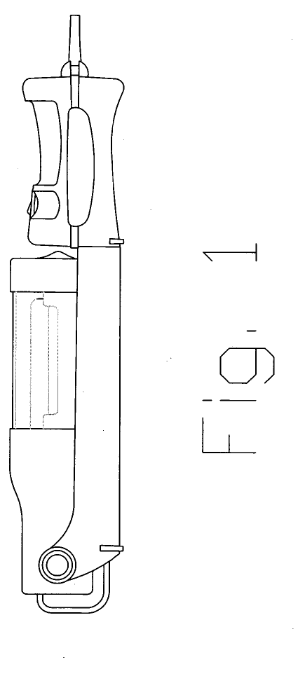

FIG. 2 is a front view with light rotated 180 degree thereof;

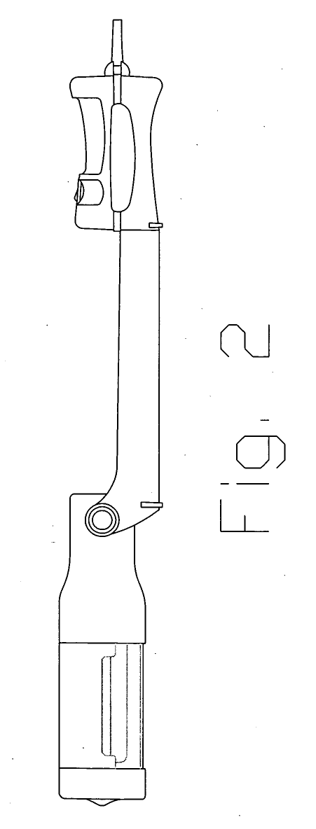

FIG. 3 is a front sectional view thereof;

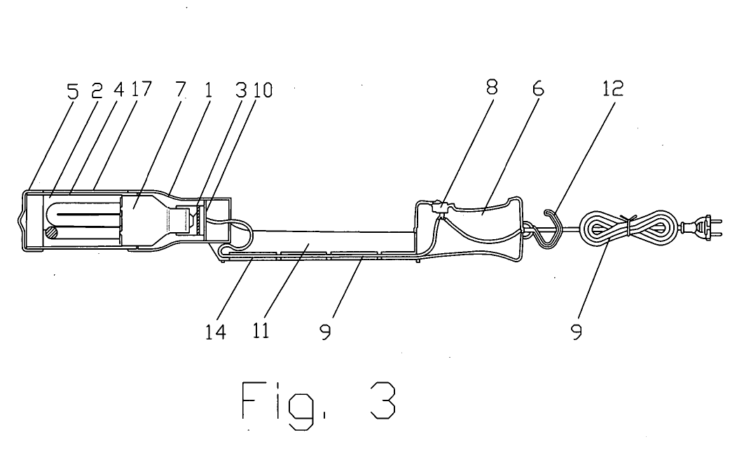

FIG. 4 is a plan view thereof;

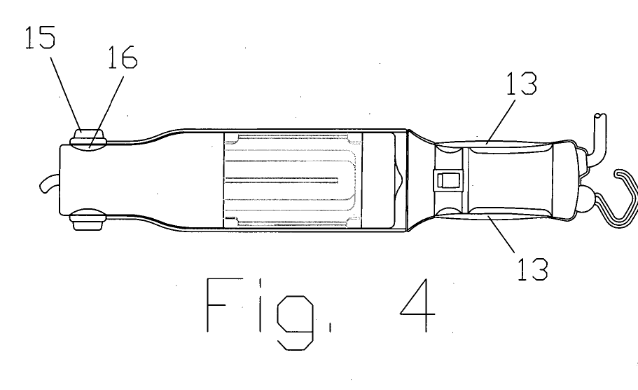

FIG. 5 is an underneath view thereof;

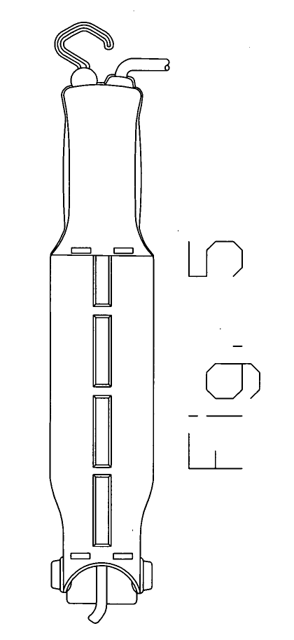

FIG. 6 is a side view thereof;

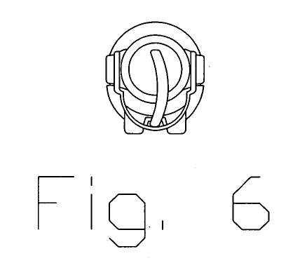

FIG. 7 is another side view thereof;

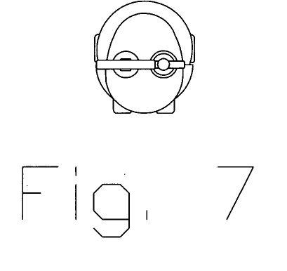

FIG. 8 is a rear view thereof;

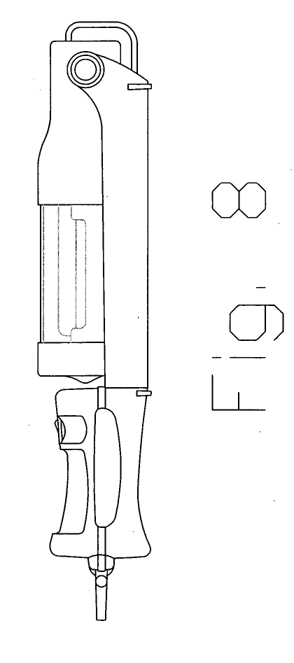

FIG. 9 is a front view with light rotating 180 degree thereof.

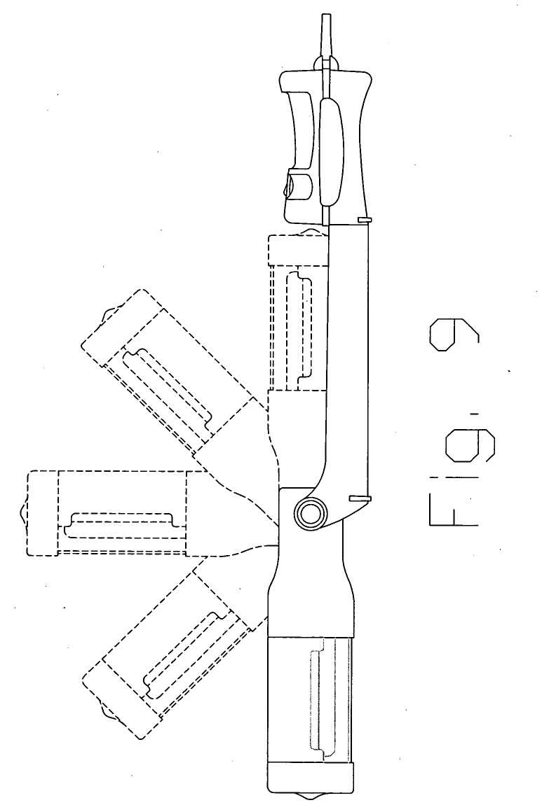

FIG. 10 is an underneath and front view with deflector removed thereof.

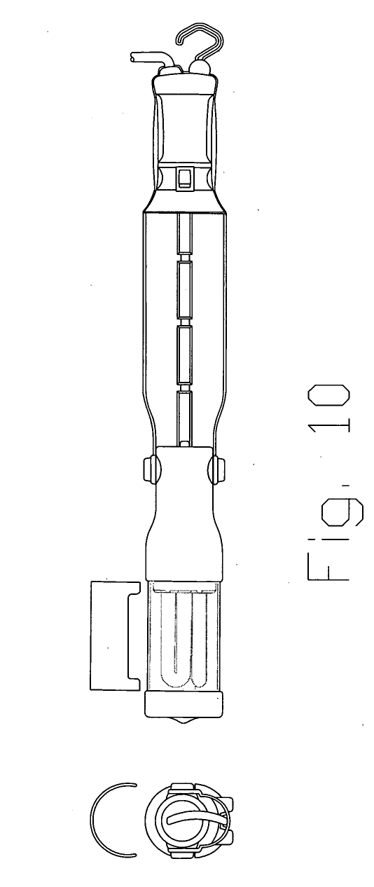

### DETAILED DESCRIPTION OF SAID PREFERRED EMBODIMENT

Said present invention comprises of a three dimensional cylinder illuminant (1). Inside said illuminant (1), there is a light source (2), a stand (3), and a shield (4) usually made of glass or other transparent materials. Said shield (4) is sealed up from said top by a sealing annular head (5) made of flexible material. Said annular head (5) may be fastened to said front end of said illuminant (1) in a dismantling manner for said convenience of bulb (7) replacement by said user.

As illustrated in all figures, said light source (2) consists of an energy-saving fluorescent bulb (7), which can be fastened to said socket (3) and is powered by said built-in power source (9) of said illuminant (1). Said power connects to said electric circuit device (8) of said hand grip (6) via said power cord, and further connects to said energy-saving fluorescent bulb (7) of said socket (3) in said illuminant (1). It is obvious that said source of power uses civil power as its source directly.

Said socket (3) is fastened to said frame (10) at said bottom of said illuminant (1). Said hand grip (6) is a rectangular cylinder structure that is fastened to an extended support (11) at one end and functions as said entrance of said power line (9) at said other end. There is an adjustable latch (12) on said side of said power line (9). Said latch (12) may hang said hand-held energy-saving searchlight at upper level to provide sufficient light source for maintenance and repair of domestic electric supply, automobiles and tour vessels. Both sides of said hand grip (6) have grip device (13) made of flexible materials for comfort of said user. On said top of said hand grip (6), there is a circuit device (8) that drives said light source.

Said extended support (11) installs an electric cord notch (14) that secures regulating power line (9). Said extended support (11) has a flange pivot latch (15) at one end, which is connected to said pivot pillar (16) at one end of said illuminant (1). Said extended support (11) provides a support for said illuminant (1), so that said illuminant (1) may connect to said extended support (11) in a flexible manner, and adjust said flange pivot latch (15) so as to secure movement of said illuminant (1). Therefore said illuminant (1) can pivot around said rotary hinge to any position within a 180° arc, so that said optimal lighting angle is achieved.

Said illuminant (1) includes an energy-saving fluorescent bulb (7) that is fastened to said socket (3) in a flexible manner and powered by said power line (9) in said illuminant. Said power is connected to said electric circuit device (8) of said hand grip (6) via power line (9) and further to said socket (3) in said illuminant to said energy-saving fluorescent bulb (7). Said illuminant (1) is mounted to a cover (4) made of glass or other transparent materials. Said annular head (5) is secured to said front end of said cover (4) in a dismantling manner. Said cover (4) has an arc-shaped light-adjusting reflective shield (17) that is secured to said surface of said cover (4) in a dismantling manner. Said above-mentioned light-adjusting reflective shield (17) can move and/or rotate on said outer surface of said cover (4), so that said light emitted by said energy-saving fluorescent bulb (7) will be reflected through said light-adjusting reflective shield (17) to better focus said light towards certain direction. It is obvious that said light-adjusting reflective shield (17) can help adjust said lighting angle.

In another word, this renovated hand-held energy-saving searchlight can be used as a flash light and is portable. It is very easy to use when used to search certain targets or when used to provide multi-angle lighting. Said product is especially helpful to high-risk workers such as policemen, firemen or soldiers.

As this invention of hand-held energy-saving searchlight has an angle-adjustable illuminant (1), it is obvious that said user of this hand-held energy-saving searchlight may use said light source without additional handling efforts. In addition, in need of sufficient source of light, said extended support (11) of this hand-held energy-saving searchlight can be securely supported on surfaces such as table or ground for said purpose of lighting up. With said adjustable latch (12) at said rear end of said hand-held energy-saving searchlight, said user may also hang said energy-saving searchlight in higher place, so as to provide sufficient light for maintenance and repair of domestic electric appliance, automobiles, vessels or other machines.

This innovative hand-held energy-saving searchlight is an important source of lighting that has found extensive application in marine or land army, public security, firefighting, emergency treatment, disciplined troop, architecture and civil vessels, as well as in daily emergency treatment and maintenance application.

What is claimed is:

1. A fluorescent working light comprises:
a three dimensional cylinder housing, inside of it contains a mean of lighting source;
a plurality of reflector is fixed around said mean of light source; and
a plurality of power cord, and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach said best lighting range and lighting angles; and
having two supporting legs can move relatively and interactively between position one and position two allowing tightly affixed at any position to provide an adjustable lighting angle, said supporting legs provide a support on plane surface for to provide a distance lighting mean with any angle over 90°, and
said supporting legs can also provide rotating positions through said adjustable hinge to any position within 270 degrees circular arc. Said provide support for said housing in a horizontal position to get said best lighting angle, and having a handle attached to said housing providing mean of carrying.

2. A fluorescent working light as recited in claim 1, wherein, said fluorescent working light is further comprises:
at least one light bulb,
at least one arc shaped reflector,
at least one set of main switch,
at least one power receptacle for external electricity,
at least one transformer, and
at least one set of circuitry and power supply.

3. A fluorescent working light as recited in claim 1, wherein supporting legs can provide an adjustable mean with a tight or loose positions so as to controlling such supporting legs in a locked position or in a rotating position to reach said best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said legs provide supports for said housing.

4. A fluorescent working light as recited in claim 1, wherein said fluorescent working light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light
housing by said user manipulation;
and a fluted heat sink mounted on said light housing, wherein said housing conductively dissipates lamp heat from said anode.

5. A fluorescent working light as recited in claim 1, wherein said fluorescent working light comprises a lighting source, has an energy saving florescent light bulb, which is located on a light base. Electricity is provided by a power source within said housing. Electricity current goes through power cord to said insides of electrical circuitry of said housing and transformer, while connects power receptacle, on/off switch, and links up with energy saving florescent bulb.

6. A fluorescent working light as recited in claim 1, wherein said fluorescent working light can draw electricity either from AC power outlet provided from public utility or from said chargeable battery directly.

7. A fluorescent working light as recited in claim 1, wherein said fluorescent working light further comprises:
a handle in a rectangular shape is longitudinally attached to said housing. A front and rear of said handle are equipped with stripes so as to provide a mean of carrying.

8. A fluorescent working light as recited in claim 1, wherein said fluorescent working light further comprises:
a battery cover is located at rear portion of said housing. Metal screws tightly locked a battery cover to said rear bump of said housing. A seal packing collar fastens said light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal said entrance of said external receptacle, thus prevent water and is more durable.

9. A fluorescent working light as recited in claim 2, wherein supporting legs can provide an adjustable mean with a tight or loose positions so as to controlling such supporting legs in a locked position or in a rotating position to reach said best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said legs provide supports for said housing.

10. A fluorescent working light as recited in claim 2, wherein said fluorescent working light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light
housing by said user manipulation;
and a fluted heat sink mounted on said light housing, wherein said housing conductively dissipates lamp heat from said anode.

11. A fluorescent working light as recited in claim 2, wherein said fluorescent working light comprises a lighting source, has an energy saving florescent light bulb, which is located on a light base. Electricity is provided by a power source within said housing. Electricity current goes through power cord to said insides of electrical circuitry of said housing and transformer, while connects power receptacle, on/off switch, and links up with energy saving florescent bulb.

12. A fluorescent working light as recited in claim 2, wherein said fluorescent working light can draw electricity either from AC power outlet provided from public utility or from said chargeable battery directly.

13. A fluorescent working light, as recited in claim 1, wherein said fluorescent working light further comprises:
a handle in a rectangular shape is longitudinally attached to said housing. A front and rear of said handle are equipped with stripes so as to provide a mean of carrying.

14. A fluorescent working light as recited in claim 1, wherein said fluorescent working light further comprises:
one screw hole for hanging. This flexible plate may be flexibly connected to said bottom of said short stand and said flexible plate may pivot around said hinge, and move to any desired position within a 180° arc.
A seal-packing collar fastens said light fixture's rear inside with a front end of said battery cover. Said battery cover provides disassembling position or a fixed position at rear portion of said housing.
